(19) United States
(12) Patent Application Publication
(10) Pub. No.: US 2007/0084503 A1
(43) Pub. Date: Apr. 19, 2007

(54) Solar energy collecting device and method for making the same

(76) Inventors: Zhanxu Huang, Fremont, CA (US); Huimin Huang, Jiaxing (CN)

Correspondence Address: SILICON VALLEY PATENT AGENCY, 7394 WILDFLOWER WAY, CUPERTINO, CA, 95014, US

(21) Appl. No.: 11/383,175

(22) Filed: May 12, 2006

Related U.S. Application Data
(63) Continuation-in-part of application No. 11/252,281, filed on Oct. 17, 2005.

(51) Int. Cl. H02N 6/00

(52) U.S. Cl. 136/246

(57) ABSTRACT

Techniques for collecting a large amount of sunlight without overheating the underlying solar cells are disclosed. According to one aspect of the techniques, a housing includes arrays of solar cells, elongated concentrating lenses, and arrays of reflectors. The solar cells are electronically connected to provide an electrical power with a certain magnitude, when exposed to sunlight. Each of the arrays of elongated concentrating lenses is positioned above and focuses the sunlight onto an array of solar cells. Each of the elongated concentrating lenses has an inner surface facing the array of solar cells, wherein the inner surface includes a plurality of elongated toothed edges to reduce heat from the sunlight being focused to the array of cells.

### CROSS-REFERENCE TO RELATED APPLICATION

The present application is continuation-in-part of U.S. application Ser. No. 11/252,281, entitled “Apparatus for collecting solar energy and method for making the same” filed on Oct. 17, 2005.

### BACKGROUND OF THE INVENTION

1. Field of the Invention

The present invention relates to the area of solar energy, and more particularly to solar energy apparatus based on solar cells and the method for making the same, wherein the solar energy apparatus is used to generate electricity from solar energy.

2. The Background of Related Art

Solar cells are commonly used in solar energy power generators. Solar cells are made of special materials called semiconductors such as silicon. As commonly seen, there are arrays of solar cells mounted onto a board to become a solar panel in order to receive sufficient sunlight. An ordinary solar energy power generator needs a large area of solar cells, the cost of such solar energy power generator can be very high. To reduce the cost, some solar energy power generators are designed to have a large concentrating lens that focuses sunlight onto a limited area, thus reducing the amount of solar cells needed. Although a concentrating lens of a big diameter can gather a huge amount of sunlight, the problem of overheating the solar cells arises.

There is a great need for solutions that can gather sunlight efficiently while, at the same time, diffuse heat caused by the focused sunlight.

### SUMMARY OF THE INVENTION

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

Broadly speaking, the present invention pertains to solar energy apparatus based on solar cells and the method for the same, wherein the solar energy apparatus is used to generate electricity from solar energy. According to one aspect of the present invention, a housing includes arrays of solar cells, elongated concentrating lenses, and arrays of reflectors. The solar cells are electronically connected to provide an electrical power with a certain magnitude, when exposed to sunlight. Each of the arrays of elongated concentrating lenses is positioned above and focuses the sunlight onto an array of solar cells. Each of the elongated concentrating lenses has an inner surface facing the array of solar cells, wherein the inner surface includes a plurality of elongated toothed edges to reduce heat from the sunlight being focused to the array of cells. According to another aspect of the present invention, the solar cells are bonded to a metallic board to facilitate further heat dissipation.

The present invention may be implemented in various forms. According to one embodiment, the present invention is an apparatus for collecting solar energy. The apparatus comprises arrays of solar cells, arrays of elongated concentrating lenses, each positioned above and having a focus at an array of solar cells, wherein each of the elongated concentrating lenses has a spherical surface facing an array of solar cells that includes a plurality of elongated toothed edges to reduce heat from the sunlight being focused to the array of solar cells, and arrays of reflectors, each positioned between two arrays of solar cells.

One of the features, benefits and advantages is to provide efficient mechanisms that collect a large amount of sunlight and at the same time facilitate the dissipation of heat on the solar cells.

Other objects, features, benefits and advantages, together with the foregoing, are attained in the exercise of the invention in the following description and resulting in the embodiment illustrated in the accompanying drawings

### BRIEF DESCRIPTION OF THE DRAWINGS

These and other features, aspects, and advantages of the present invention will become better understood with regard to the following description, appended claims, and accompanying drawings where:

FIG. 1 shows a cross-section view of a solar collecting device that includes a housing, an array of elongated concentrating lenses, solar cells, means for dissipating heat and reflectors;

FIG. 2 shows arrays of elongated concentrating lenses, each covering an array of solar cells;

FIG. 3 shows an exemplary embodiment of the internal side of each of the lenses facing the solar cells, the inner side includes a plurality of elongated toothed edges; and

FIG. 4 shows a layout including arrays of the solar cells that are electronically connected with wires.

### DETAILED DESCRIPTION OF THE PREFERRED EMBODIMENT

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

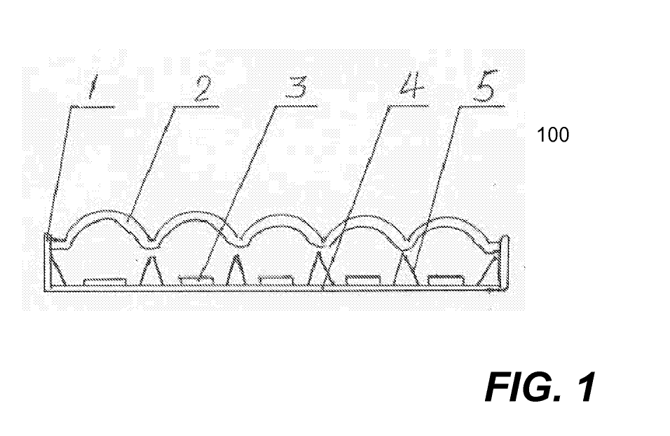

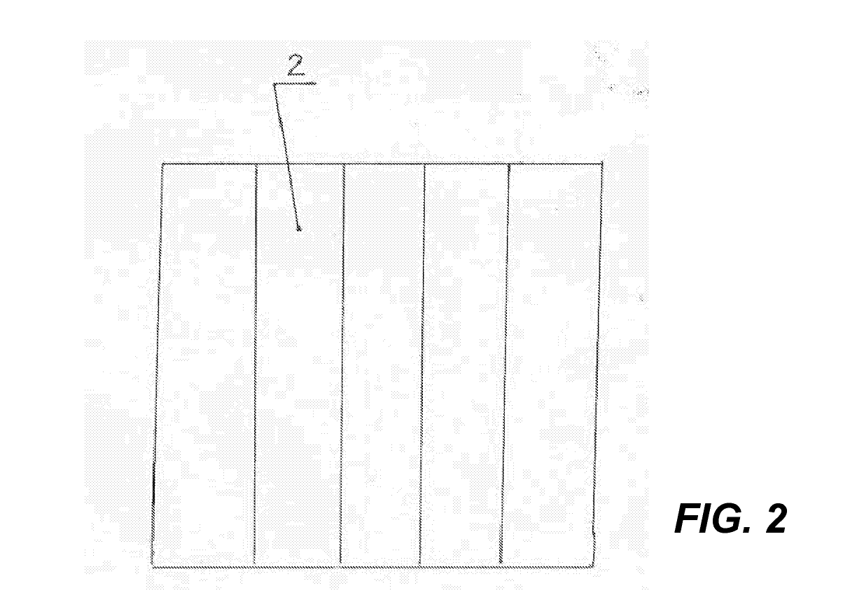

Referring now to the drawings, in which like numerals refer to like parts throughout the several views. FIG. 1 shows a cross-section view of a solar collecting device 100 that includes a housing 1, an array of elongated concentrating lenses 2, solar cells 3, means 4 for dissipating heat and reflectors 5. According to one embodiment, the housing 1 is made from a solid material (e.g., hardened plastic or aluminum) and served as a base to hold or put together the lenses 2, the solar cells 3, the means 4 for dissipating heat and the reflectors 5. Each of the elongated concentrating lenses 2, as shown in FIG. 2, covers an array of solar cells 3.

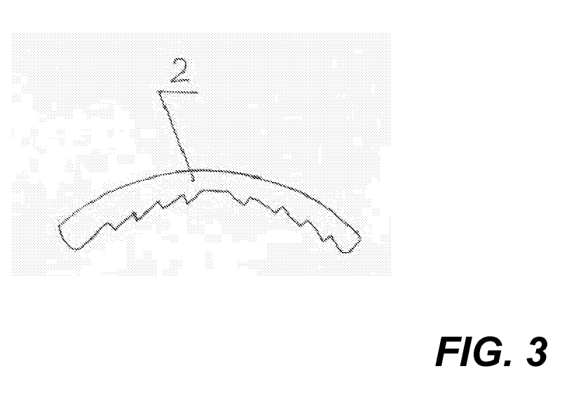

According to one embodiment, the internal side of each of the lenses 2 facing the solar cells 3 includes a plurality of elongated toothed edges as shown in FIG. 3. Each of the lenses 2 so designed has been proved that it can concentrate a large amount of sunlight onto solar cells underneath while, at the same time, dissipating heat from the sunlight

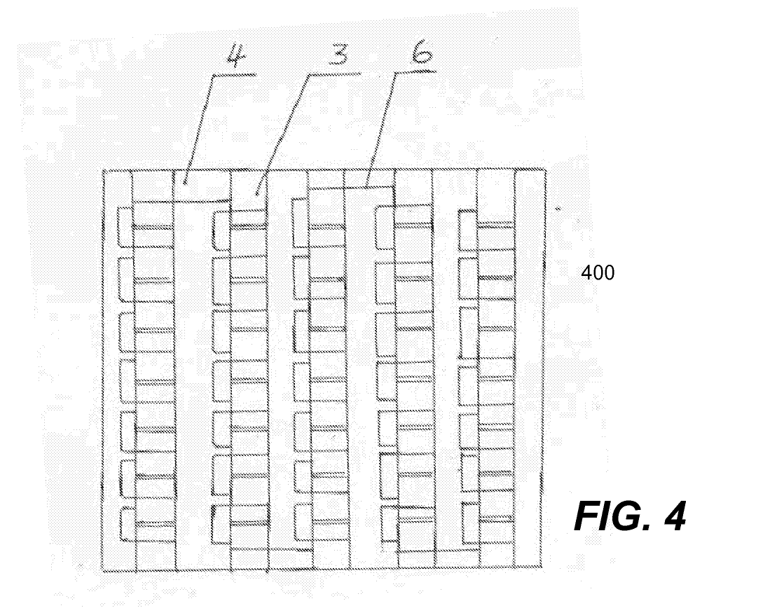

Referring now to FIG. 4, there shows a layout 400 including arrays of the solar cells 3 that are electronically connected with wires 6. The cells in an array are also electronically connected. Thus the power generated in each of the cells is accumulated to produce an electrical power with certain magnitude and can be coupled out via an electrode. To further reduce heat caused by the focused sunlight, in one embodiment, the solar cells 3 are attached onto a metallic board 402 that may be coated with a type of anticorrosion material.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

1. An apparatus for collecting solar energy, the apparatus comprising:
arrays of solar cells, electronically connected to provide an electrical power with a certain magnitude; and
arrays of elongated concentrating lenses, each positioned above and focusing the sunlight onto an array of solar cells, each of the elongated concentrating lenses has an inner surface facing the array of solar cells, wherein the inner surface includes a plurality of elongated toothed edges to reduce heat from the sunlight being focused to the array of cells.

2. The apparatus as recited in claim 1, wherein the arrays of solar cells are respectively affixed onto a board.

3. The apparatus as recited in claim 2, further comprising an array of elongated reflectors, each of the reflectors is positioned between two arrays of solar cells.

4. The apparatus as recited in claim 3, wherein the board is metallic to facilitate dissipation of the heat in the solar cells.

5. The apparatus as recited in claim 4, further comprising a housing with which the board is integrated.

6. An apparatus for collecting solar energy, the apparatus comprising:
arrays of solar cells;
arrays of elongated concentrating lenses, each positioned above and having a focus at an array of solar cells, wherein each of the elongated concentrating lenses has a spherical surface facing an array of solar cells that includes a plurality of elongated toothed edges to reduce heat from the sunlight being focused to the array of solar cells; and
arrays of reflectors, each positioned between two arrays of solar cells.

7. The apparatus as recited in claim 6, wherein the arrays of solar cells and the reflectors board are respectively affixed to a metallic board to facilitate dissipation of heat in the solar cells.
